(19) United States
(12) Patent Application Publication
(10) Pub. No.: US 2013/0139679 A1
(43) Pub. Date: Jun. 6, 2013

(54) PISTON ASSEMBLY FOR A FLUID TRANSLATING DEVICE

(71) Applicant: Bryan Nelson, Lacon, IL (US)

(72) Inventor: Bryan Nelson, Lacon, IL (US)

(73) Assignee: Caterpillar Inc., Peoria, IL (US)

(21) Appl. No.: 13/308,822

(22) Filed: Dec. 1, 2011

(51) Int. Cl. F15B 15/24; F16J 15/18

(52) U.S. Cl. 92/13; 92/165 R

(57) ABSTRACT

A piston assembly for use in the cylinder block of a fluid translating device such as a hydraulic pump or motor. The piston assembly has an inner core having a working end, a driven end and an axial stem. An outer sleeve is positioned about an axial stem of the inner core of the piston assembly. The outer sleeve is composed of a material, which is made from a material being lighter weight than steel, and secured to the axial stem. A slipper includes a piston receiving portion for pivotally receiving the driven end of the piston assembly. The piston assembly and slipper include a lubrication passage providing a path for pressurized fluid.

### TECHNICAL FIELD

The present disclosure relates to pistons for fluid translating devices and, more particularly, to a lightweight piston assembly for such a device.

BACKGROUND

Fluid translating devices typically include a rotating cylinder block containing a plurality of reciprocating pistons that are attached to slippers in operational engagement with a swashplate. Such fluid translating devices may operate as either a pump or a motor. Typically, the pistons that are utilized in fluid translating devices of the aforementioned type have been manufactured from a metallic material. These pistons are typically constructed of solid steel that is heavy and reduces the maximum speed at which they can operate due to high cylinder block tipping forces and high centrifugal forces.

The cylinder block tipping occurs when the centrifugal forces acting on the pistons cause the port plate to separate from the cylinder block face. When this happens the pump is unable to discharge fluid to the system. This is one of the limiters of maximum speed at which a pump can safely operate. This phenomenon is a function of piston mass, stroke length, and speed. Reducing the mass of the piston increases the speed at which the cylinder block will tip, which in turn increases the power density of the pump.

A known technique for increasing the rotational speeds while reducing the centrifugal forces of the fluid translating device is to utilize hollow pistons. However, hollow piston construction has been found to produce adverse side effects due mainly to the compressibility of the oil that fills the piston cavity and the cost to manufacture the hollow pistons. The compressibility of the fluid has a marked effect on the overall efficiency of the unit, and also produces cavitation, erosion, noise and undesirable moments on the swashplate mechanism.

There are at least three other types of filled/hollow pistons. First, welded pistons having a metal stem with a sleeve welded to the outside creating an enclosed hollow cavity or an end cap welded to a hollow body. Next, hollow metallic pistons that are filled with plastic. Lastly, composite pistons having a low density metallic core with a steel exterior formed thereto. Welded pistons are costly to manufacture because of the machining of two steel components and may not meet the mass requirements and weight.

Filling the pistons by pouring a liquid plastic material into them has also been tried. When solidified, the plastic has a bulk modulus greater than that of oil. This method has proven to be costly, and it has been difficult to reliably retain the material within the piston or adhere it to the piston wall. Many plastics do not meet the bulk modulus requirement.

Having a metallic core with a steel exterior requires as much machining as the welded hollow pistons but instead of welding requires an insert be positioned into a hollow cavity and then the end of the steel exterior needs to be formed to encapsulate the low density metallic core. On such an example of this type of piston is disclosed in U.S. Pat. No. 5,076,148 issued to Hydromatik Gmbh on Dec. 31, 1991. This approach reduces the mass of the piston but does not appreciate other alternative improvements.

The present invention is direct to overcoming one or more of the problems set forth above.

### SUMMARY OF THE INVENTION

In one aspect of the present disclosure, a piston assembly is disclosed. The piston assembly includes a slipper having a slipper plate and a piston receiving portion. The piston assembly also includes an inner core having a driven end and a working end and an axial stem. An outer sleeve is attached to and positioned about the axial stem.

In accordance with another aspect of the present disclosure a variable fluid translating device is disclosed. The variable fluid translating device has a multi piece housing supporting a rotating cylinder block. A main shaft is supported within the multipiece housing and operatively connected to the cylinder block. A swashplate is provided at a transverse angle relative to a longitudinal axis and positioned adjacent the rotating cylinder block. A piston assembly is reciprocatingly positioned in each of the cylinder bores of the cylinder block, each piston assembly has a slipper having a slipper plate and a piston receiving portion, an inner core having a driven end and a working end and an axial stem and an outer sleeve attached to and positioned about the axial stem.

### BRIEF DESCRIPTION OF THE DRAWINGS

FIG. 1 is a perspective view of a fluid translating device constructed in accordance with the teachings of the present disclosure;

FIG. 2 is a longitudinal cross-sectional view of the fluid translating device taken along line 2-2 of FIG. 1;

FIG. 3 is an enlarged sectional view of a composite piston in accordance with the teachings of the present disclosure;

### DETAILED DESCRIPTION

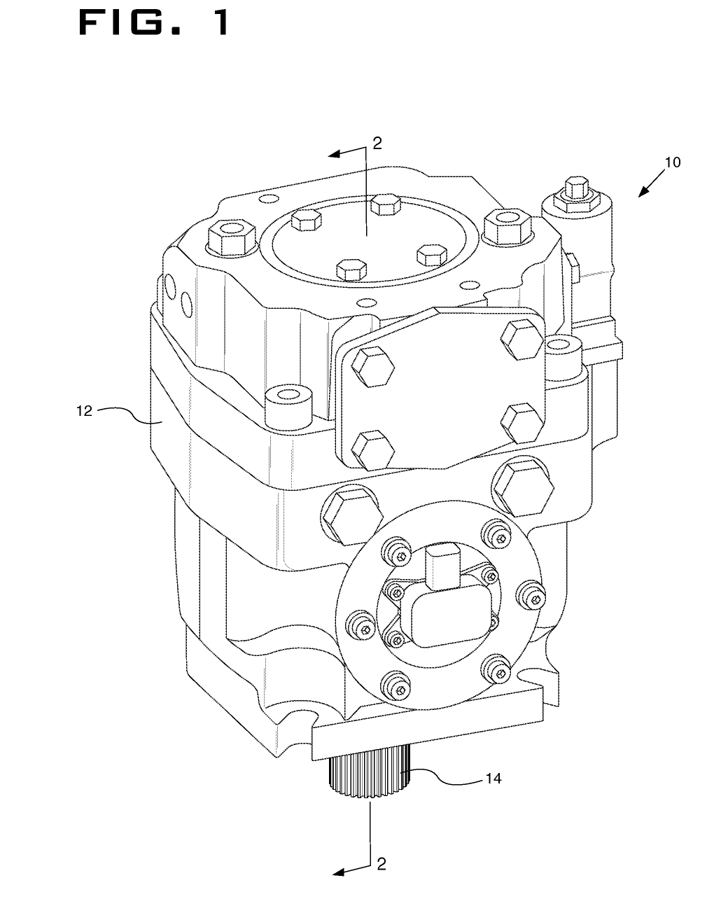

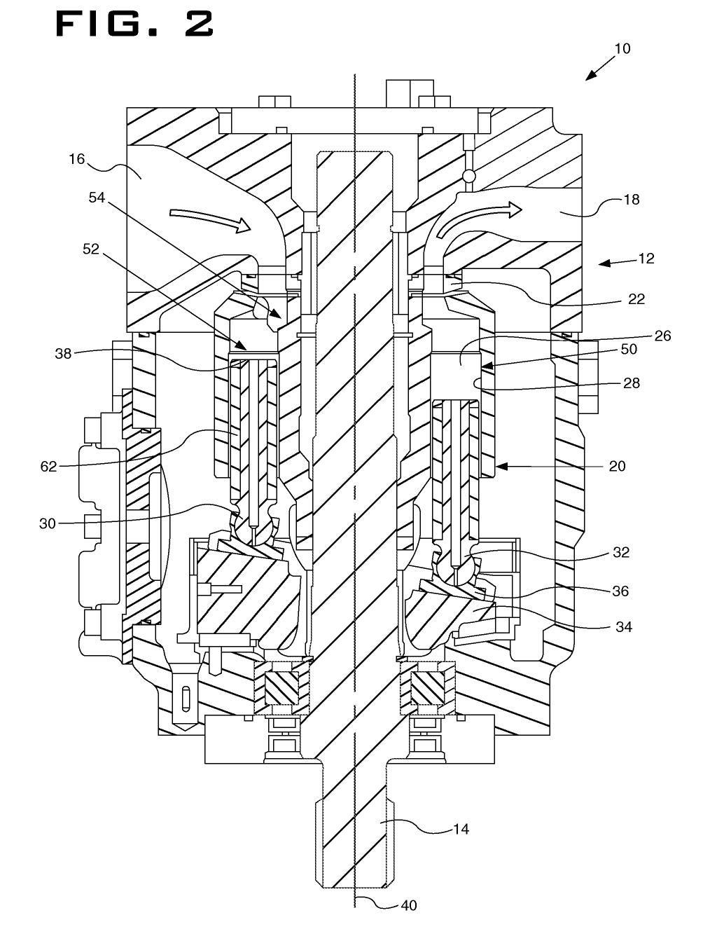

Referring now to the drawings, with specific reference to FIG. 1, a fluid translating device generally referred to by reference numeral 10 is shown. Specifically, in the example shown the fluid translating device 10 is a variable displacement pump, but equally could be a fluid motor constructed in accordance with the teachings of the present disclosure. As shown, the fluid translating device 10 includes a multi-piece housing 12 from which extends a drive shaft 14 for connection to a transmission or internal combustion engine of a larger machine (none of which are shown). When the machine is in operation, the fluid translating device 10 is designed to draw hydraulic fluid in through inlet 16 and expel hydraulic fluid out through outlet 18 (See FIG. 2) for communication to implements or working components of the machine (not shown).

With reference to FIG. 2, a cross-sectional view of the fluid translating device 10, taken along lines 2-2 of FIG. 1 is shown. It can be seen that the drive shaft 14 is operatively connected to a cylinder block 20 that is adapted to rotate within the multi-piece housing 12. The cylinder block 20 is axially positioned in cooperation with a port plate 22 which itself is in fluid communication with the inlet 16 and outlet 18.

The cylinder block 20 includes a plurality of cylinder bores 26 machined therein. Each cylinder bore 26 is evenly radially spaced within the cylinder block 20 and includes a cylinder wall 28. As shown best in FIG. 2, a piston assembly 30 is reciprocatingly positioned within each of the cylinder bores 26. More specifically, each piston assembly 30 is adapted to reciprocate within the cylinder bores 26 as the piston assemblies 30 and cylinder block 20 rotate within the multi-piece housing 12 through intake and exhaust strokes.

In order to reciprocate the piston assemblies 30 within the cylinder bores 26, a driven end 32 of each piston assembly 30 is rotatably and slideably engaged with a swashplate 34 by way of a slipper assembly 36. As will be noted, the swashplate 34 can be provided at a transverse angle relative to a centerline 40 of the drive shaft 14. During operation with the swashplate 34 positioned at an angle, the cylinder block 20 and piston assemblies 30 rotate either under power from the drive shaft or the influence of hydraulic fluid entering and exiting the cylinder bores 26, the piston assemblies 30 are caused to reciprocate back and forth within the cylinder bores 26. Moreover, the angle at which the swashplate 34 is positioned necessarily dictates the resulting volume of fluid flow into or out of the fluid translating device 10. For example, if the swashplate 34 were positioned at an angle perpendicular to the drive shaft 14, then there would be no flow of fluid at all. However, with each degree the swashplate 34 is pivoted away from perpendicular, the resulting flow of the fluid is increased.

Opposite to the driven end 32, each piston assembly 30 includes a working end 38. Also shown in FIG. 2, the working end 38 is adapted to reciprocate between a bottom dead center position 50, and a top dead center position 52. As one of the ordinary skill in the art will understand, with the fluid translating device 10 operating as a pump, during the filling or intake stroke of each piston assembly 30, the working end 38 moves from the top dead center position 52 to the bottom dead center position 50; and during the exhaust stroke, the working end 38 moves from a bottom dead center position 50 to the top dead center position 52. The hydraulic fluid drawn in during the intake stroke and expelled during the exhaust stroke is navigated through a plurality of fluid flow apertures 54.

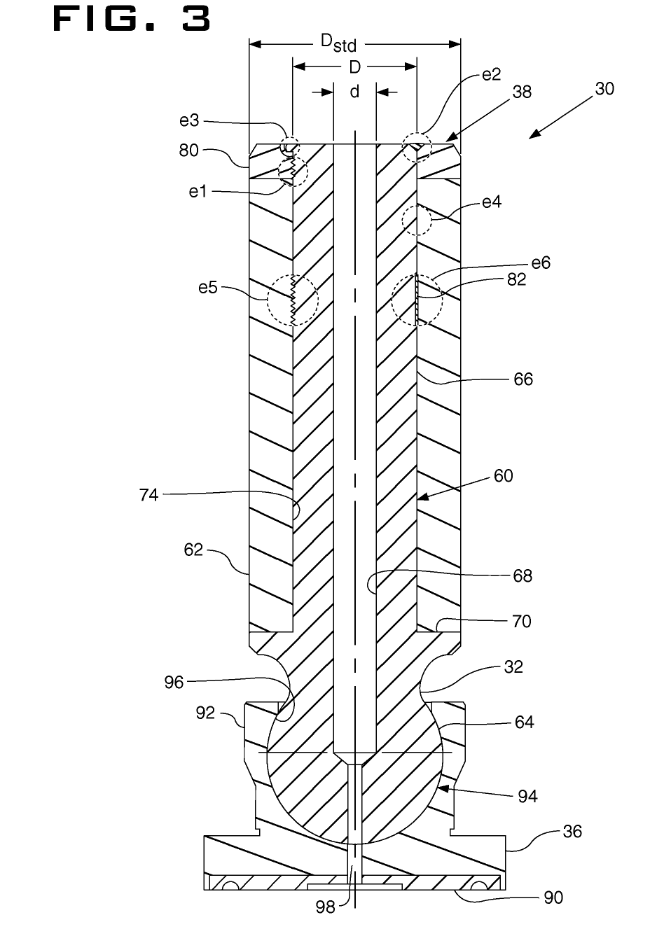

Referring now to FIG. 3, the piston assembly 30 will be described in more detail. Piston assembly 30 is a multi-piece unit consisting of an inner core 60, an outer sleeve 62 and the slipper assembly 36. The inner core 60 has a ball end 64 formed on the driven end 32 for connecting to the slipper assembly 36. It should be understood that placing a socket in the driven end 32 of the piston assembly 30 and a ball end on the slipper assembly 36 would work sufficiently well. As shown the inner core 60 has a longitudinally extending axial stem 66 with a shoulder 70 positioned adjacent the driven end 32. The axial stem 66 of the inner core 60 has an outer diameter “D” and a through passage “d”. The through passage “d” is a stepped passage 68 that is used in a known fashion to feed lubricant between the ball end 64 and the slipper assembly 36 and may be used to lubricate the interface between the slipper assembly 36 and the swashplate 34.

By sizing the axial stem 66 appropriately the designer can utilize the structural attributes that further assist the piston assembly 30 to maintain the characteristics of a solid steel piston. For example, if the outer diameter “D” and the inner diameter “d” of the axial stem 66 of the piston assembly 30 shown in FIG. 3. Where “D” is the outer diameter of the axial stem 66 and “d” is the diameter of the stepped passage 68, from the working end 38 to the shoulder 70, are designed correctly using the equation for the section modulus of a cylinder below:

Z=π(D⁴−d⁴)÷32D

Comparing this to a standard solid steel piston not shown and using the section modulus equation:

Z=7π(D_{std}⁴−d⁴)÷32D_{std}

Where “D_{std}” is the outer diameter of a standard piston and “d” would be the diameter of the stepped passage 68, from the working end 38 to the driven end 32 adjacent the ball end 64. The stiffness of the axial stem 66 of the piston assembly 30 shown in FIG. 3, will have the same stiffness of a standard steel piston. This will aid in reducing the weight and assist in maintaining the strength of the piston assembly 30.

The outer sleeve 62 is an annular member having an inner sleeve wall 74 operatively coinciding with the outer diameter “D” of the axial stem 66 of the inner core 60. Outer sleeve 62 is positioned about the axial stem 66. Outer sleeve 62 is manufactured of a material being lighter weight than the inner core 60. For example, outer sleeve 62 may be manufactured from aluminum, titanium, magnesium, or carbon fiber. The material that is chosen for the outer sleeve 62 is of a lighter material than steel and provides opportunities that will be described in more detail below. Still referring to FIG. 3, the outer sleeve 62 may be secured to the axial stem 66 in a variety of methods. In one example a retainer cap 80 may be threaded to the axial stem 66 as shown in the example highlighted at “e1”. Retainer cap 80 may also be welded to the axial stem 66 of the inner core 60 as designated at “e2”. Another method may include securing the retainer cap 80 to the axial stem 66 by deforming or swaging a portion of the axial stem 66 to positively secure the retainer cap 80 designated at “e3”. Depending on the operational characteristics the retainer cap 80 may not be needed. Instead the outer sleeve 62 may be secured directly to the axial stem 66 as by press fit designated at “e4”. Alternatively, the outer sleeve 62 may be threading onto the axial stem 66 as shown in call out “e5”. A chemical bonding agent 82 may also be used as shown at “e6”.

Still referring to FIG. 3 slipper assembly 36 will be described in more detail. Slipper assembly 36 is a multi-piece unit consisting of a slipper plate 90 and an outer body 92. Outer body 92 includes a piston receiving portion 94. Piston receiving portion 94 includes a semi spherical socket 96 and a lubricating passage 98. Outer body 92 may be securedly attached to slipper plate 90 and may be manufactured from steel. Slipper plate 90 is made from a brass alloy material known in the art. The outer body 92 alternatively may be made of a material being lighter weight than steel. For example, outer body 92 may be manufactured from aluminum, titanium, magnesium, or carbon fiber. The material that is chosen for the outer body 92 is of a material that is lighter than steel and aids in reducing the overall mass of the piston assembly 30 and slipper assembly 36. In a similar manner to the piston assembly 30 the components of the slipper assembly 36 may be secured to each other in a variety of manners. Those being threading, press fit, chemically bonded or swaging.

### INDUSTRIAL APPLICABILITY

The piston assembly 30 and the slipper assembly 36 have opportunities over currently known designs. The piston assembly 30 and slipper assembly 36 may aid in reducing the overall weight or mass of these assemblies. The reduction in weight allows the fluid translating device 10 to operate at higher operating speeds, increasing the overall power density and reducing the likelihood of cylinder block tipping as described above. Additionally, by positioning the lighter weight material on the outside of the piston assembly 30 and utilizing the thermal expansion differences between the outer sleeve 62 and the inner core 60 additional benefits may apparent that have not been previously realized.

For example, if the material chosen for the outer sleeve 62 is aluminum the thermal expansion differences between the outer sleeve 62 and the inner core 60 can be beneficial. When the fluid translating device is operating in a cold environment the fluid to be pumped is cold and more viscous during the initial operation. Therefore the piston assembly 30 can be designed to have a greater clearance between the outer sleeve 62 and the cylinder wall 28 of the cylinder bore 26. In this example the greater clearance between the piston assembly 30 and the cylinder wall 28 of the cylinder bore 26 will reduce the drag between the rotating components of the fluid translating device 10. As fluid translating device 10 continues to operate the internal components of the fluid translating device and the fluid will begin to warm up. When the components begin to warm the outer sleeve 62 will expand at a faster rate than the cylinder bores 26 of the cylinder block 20 reducing the clearance therebetween. Thus the fluid translating device 10 will operate more efficiently during a cold start up and then continue to improve until reaching peak operating temperature.

What is claimed is:

1. A piston assembly, comprising:
a slipper having a slipper plate and a piston receiving portion;
an inner core having a driven end and a working end and an axial stem; and
an outer sleeve attached to and positioned about the axial stem, said outer sleeve being made from a material being lighter weight than steel.

2. The piston assembly of claim 1 wherein the outer sleeve being a one of aluminum, titanium and magnesium.

3. The piston assembly of claim 2 wherein the outer sleeve is secured to the axial stem of the inner core by one of threading, press fit, swaging and chemical bonding.

4. The piston assembly of claim 2 wherein the outer sleeve is secured to the axial stem of the inner core by a retaining cap.

5. The piston assembly of claim 4 wherein the retaining cap is secured to the axial stem of the inner core by welding.

6. The piston assembly of claim 1 wherein the driven end of the inner core includes a ball end for receiving a semispherical socket of the piston receiving portion of the slipper.

7. The piston assembly of claim 1 wherein the piston receiving portion of the slipper includes a ball end.

8. The piston assembly of claim 1 wherein the axial stem of the inner core having a section modulus being equal to a standard steel piston.

9. The piston assembly of claim 1 wherein the slipper assembly and the piston assembly have a lube passage defined therethrough extending from the working end of the pistons assembly to the slipper plate of the slipper assembly.

10. A variable fluid translating device, comprising:
a multipiece housing;
a rotating cylinder block, rotatably positioned within the multipiece;
a main shaft being supported within the multipiece housing and being operatively connected to the cylinder block;
a swashplate provided at a transverse angle relative to the longitudinal axis and positioned adjacent the rotating cylinder block;
a piston assembly, being reciprocatingly positioned in each of the cylinder bores of the cylinder block, each piston assembly including;
a slipper having a slipper plate and a piston receiving portion, the slipper plate being in operative contact with the swashplate;
an inner core having a driven end and a working end and an axial stem; and
an outer sleeve attached to and positioned about the axial stem, said outer sleeve being made from a material being lighter weight than steel.

11. The variable fluid translating device of claim 10 wherein the outer sleeve being a one of aluminum, titanium and magnesium.

12. The variable fluid translating device of claim 10 wherein the outer sleeve is secured to an axial stem of said inner core by one of threading, press fit, swaging and chemical bonding.

13. The variable fluid translating device of claim 10 wherein the outer sleeve is secured to an axial stem of said inner core by a retaining cap.

14. The variable fluid translating device of claim 13 wherein the retaining cap is secured to the axial stem of said inner core by welding.

15. The variable fluid translating device of claim 9 wherein the driven end of the inner core includes a ball end for receiving a semispherical socket of the piston receiving portion of the slipper.

16. The variable fluid translating device of claim 9 wherein the piston receiving portion of the slipper includes a ball end.

17. The variable fluid translating device of claim 9 wherein the axial stem of the inner core having a section modulus being equal to a standard steel piston.

18. The variable fluid translating device of claim 9 wherein the slipper assembly and the piston assembly have a lube passage defined therethrough extending from the working end of the pistons assembly to the slipper plate of the slipper assembly.
